(19) United States
(12) Patent Application Publication
(10) Pub. No.: US 2024/0077462 A1
(43) Pub. Date: Mar. 7, 2024

(54) ACCURATE CHROMATOGRAPHY-MASS SPECTRAL ANALYSIS OF MIXTURES

(71) Applicant: CERNO BIOSCIENCE LLC, Las Vegas, NV (US)

(72) Inventors: Yongdong WANG, Las Vegas, NV (US); Don KUEHL, Windham, NH (US); Stacey SIMONOFF, Portsmouth, NH (US)

(73) Assignee: CERNO BIOSCIENCE LLC, Las Vegas, NV (US)

(21) Appl. No.: 18/242,180

(22) Filed: Sep. 5, 2023

Related U.S. Application Data
(60) Provisional application No. 63/403,563, filed on Sep. 2, 2022.

(51) Int. Cl. G01N 30/72; G01N 30/86

(52) U.S. Cl. CPC G01N 30/7206; G01N 30/8624; G01N 2030/025

(57) ABSTRACT

A method, for use in a mass spectrometer or computer software, and computer readable medium, for acquiring mass spectral data; comprising acquiring mass spectral data for a sample; selecting a relevant retention time window for presence of possible compounds of interest; using positively identified analytes from a sample run to convert retention time into retention index; determining a retention index range for said relevant retention time window; using the acquired spectral data in said relevant retention time window to perform a spectral library search to identify possible compounds; selecting a subset of possible compounds based on at least one of their retention index values and spectral library search scores; performing a regression analysis, between the spectral data within the retention time window and the library spectrum of at least one of the subset of possible compounds; and reporting the regression coefficients as representative of the concentrations or chromatograms of said possible compounds.

### CROSS REFERENCE TO RELATED PATENT APPLICATIONS/PATENTS

U.S. Pat. Nos. 6,983,213, 7,493,225 and 7,577,538; International Patent Application PCT/US2004/013096, filed on Apr. 28, 2004; U.S. Pat. No. 7,348,553; International Patent Application PCT/US2005/039186, filed on Oct. 28, 2005; U.S. Pat. No. 8,010,306, International Patent Application PCT/US2006/013723, filed on Apr. 11, 2006; U.S. Pat. No. 7,781,729, International Patent Application PCT/US2007/069832, filed on May 28, 2007; U.S. provisional patent application Ser. No. 60/941,656, filed on Jun. 2, 2007 and as International Patent Application PCT/US2008/065568 published as WO 2008/151153; U.S. provisional patent application Ser. No. 62/632,414, filed on Feb. 19, 2018 and as International Patent Application PCT/US2019/018568 published as WO2019161382; U.S. provisional patent application Ser. No. 62/830,832, filed on Apr. 8, 2019 and as U.S. patent application Ser. No. 16/843,505 published as US 2020-0232956 A1; United States Provisional Patent Application Ser. No. 63/273,676 (corresponding to PCT/US22/48228 filed on Nov. 28, 2022) and 63/305,969 (corresponding to PCT/US23/12187 filed on Feb. 2, 2023).

The entire teachings of these patent documents are hereby incorporated herein by reference, in their entireties, for all purposes.

### FIELD OF THE INVENTION

The present invention generally relates to the field of chromatographic separation connected with a spectral detection system such as gas chromatography (GC) with Mass Spectrometry (MS) detection and, more particularly, to methods for acquiring, processing, and analyzing the resulting separation and spectral data.

### BACKGROUND OF THE INVENTION

Mass Spectrometry (MS) is a 100-years-old technology that relies on the ionization of molecules, the dispersion of the ions by their masses, and the proper detection of the ions on the appropriate detectors. There are many ways to achieve each of these three key MS processes which give rise to different types of MS instrumentations having distinct characteristics.

Many ionization techniques are available to ionize molecules entering MS system so that they can be properly charged before mass dispersion. These ionization schemes include Electrospray Ionization (ESI), Electron Impact Ionization (EI) through the impact of high-energy electrons, Chemical Ionization (CI) through the use of reactive compounds, and Matrix-Assisted Laser Desorption and Ionization (MALDI).

Once the molecules have been charged through ionization, each ion will have a corresponding mass-to-charge (m/z) ratio, which will become the basis to mass dispersion. Based on the physical principles used, there are many different ways to achieve mass dispersion and subsequent ion detection, resulting in mass spectral data similar in nature but different in details. A few of the commonly seen configurations include: magnetic/electric sector; quadrupoles; Time-Of-Flight (TOF); and Fourier Transform Ion-Cyclotron Resonance (FT ICR).

The sector MS configuration is the most straight-forward mass dispersion technique where ions with different m/z ratios would separate in an electric/magnetic field and exit this field at spatially separated locations where they will be detected with either a fixed array of detector elements or a movable set of small detectors that can be adjusted to detect different ions depending on the application. This is a simultaneous configuration where all ions from the sample are separated simultaneously in space rather than sequentially in time.

The quadrupoles configuration is perhaps the most common MS configuration where ions of different m/z values will be filtered out of a set of (usually 4) parallel rods through the manipulation of RF/DC ratios applied to these rod pairs. Only ions of a certain m/z value will survive the trip through these rods at a given RF/DC ratio, resulting in the sequential separation and detection of ions. Due to its sequential nature, only one detector element is required for detection. Another configuration that uses ion traps can be conceptually considered a special example of quadrupole MS.

The Time-Of-Flight (TOF) configuration is another sequential dispersion and detection scheme that lets ions enter through a high vacuum flight tube before detection. Ions of different m/z values would arrive at different times to the detector and the arrival time can be related to the m/z values through the use of known calibration standard(s).

In Fourier Transform Ion-Cyclotron Resonance (FT ICR), all ions can be introduced to an ion cyclotron where ions of different m/z ratios would be trapped and resonate at different frequencies. These ions can be pulsed out through the application of a Radio Frequency (RF) signal and the ion intensities measured as a function of time on a detector. Upon Fourier transformation of the time domain data measured, one obtains the frequency domain data where the frequency can be related back to m/z through the use of known calibration standard(s). Orbitrap MS systems can be conceptually considered as a special case of FT MS.

As discussed in the cross-referenced U.S. Pat. No. 6,983,213, a mass spectral data trace is typically subjected to peak analysis where peaks (ions) are identified. This peak detection routine is a highly empirical and compounded process where peak shoulders, noise in data trace, baselines due to chemical backgrounds or contamination, isotope peak interferences, etc., are considered. For the peaks identified, a process called centroiding is typically applied to report only two data values, m/z location and estimated peak area (or peak height), wherever an MS peak is detected. While highly efficient in terms of data storage, this is a process plagued by many adjustable parameters that can make an isotope appear or disappear with no objective measures of the centroiding quality, due to the many interfering factors mentioned above and the intrinsic difficulties in determining peak areas in the presence of other peaks and/or baselines. Unfortunately for many MS systems, especially quadrupole MS systems, this MS peak detection and centroiding are conventionally set up by default, as part of the MS method, to occur during data acquisition down at the firmware level, leading to irreparable damages to the MS data integrity, even for pure component mass spectral data in the absence of any spectral interferences from other co-existing compounds or analytes. As pointed out in U.S. Pat. No. 6,983,213, these damages or disadvantages include:
a. Lack of mass accuracy on the most commonly used unit mass resolution MS systems. The centroiding process forces the reported mass value into integer m/z with ±1 Da or other m/z values with at least ±0.1 Da mass error, whereas the properly calibrated raw profile mode MS data (without centroiding) using the method disclosed in U.S. Pat. No. 6,983,213 can be accurate to ±0.005 Da, a factor of approximately 100 improvement.
b. Large peak integration error. Centroiding without full mass spectral calibration including MS peak shape calibration suffers from uncertainty in mass spectral peak shape, its variability, the isotope peaks, the baseline and other background signals, the random noise, leading to both systematic and random errors for either strong or weak mass spectral peaks.
c. Large isotope abundance error. Separating the contributions from various closely located isotopes (e.g., A and A+1) on conventional MS systems with unit mass resolution either ignores the contributions from neighboring isotope peaks or over-estimates them, resulting in errors for dominating isotope peaks and large biases for weak isotope peaks or even complete elimination of the weaker isotopes.
d. Nonlinear operation. The centroiding typically uses a multi-stage disjointed process with many empirically adjustable parameters during each stage. Systematic errors (biases) are generated at each stage and propagated down to the later stages in an uncontrolled, unpredictable, and nonlinear manner, making it impossible for the algorithms to report meaningful statistics as measures of data processing quality and reliability.
e. Dominating systematic errors. In most of MS applications, ranging from industrial process control and environmental monitoring to protein identification or biomarker discovery, instrument sensitivity or detection limit has always been a focus and great efforts have been made in many instrument systems to minimize measurement error or noise contribution in the signal. Unfortunately, the typical centroiding process currently in use creates a source of systematic error even larger than the random noise in the raw data, thus becoming the limiting factor in instrument sensitivity.
f. Mathematical and statistical inconsistency. The many empirical approaches currently used in centroiding make the whole processing inconsistent either mathematically or statistically. The peak processing results can change dramatically on slightly different data without any random noise or on the same synthetic data with slightly different noise. In order words, the results of the peak centroiding are not robust and can be unstable depending on a particular experiment or data acquisition.
g. Instrument-to-instrument or tune-to-tune variability. It has usually been difficult to directly compare raw mass spectral data from different MS instruments due to variations in the mechanical, electromagnetic, or environmental tolerances. The typical centroiding applied to the actual raw profile mode MS data, not only adds to the difficulty of quantitatively comparing results from different MS instruments due to the quantized nature of the centroiding process and centroid data, but also makes it difficult, if not impossible, to track down the source or possible cause of the variability once the MS data have been reduced to centroid data.

For a well separated analyte with pure mass spectrum and without any spectral interferences, MS centroiding is quite problematic, due to the above listed reasons. For unresolved or otherwise co-eluting analytes or compounds in complex samples (e.g., petroleum products or essential oils) even after extensive chromatographic separation (e.g., 1 hour GC separation of essential oils or LC separation of biological samples with post translational modification such as deamidation), the above centroid processing problem would only be further aggravated due to the mutual mass spectral interferences present and the quantized nature of the MS centroids, which makes mass spectral data no longer linearly additive. This necessarily makes the MS centroid spectrum of a mixture different from the sum of MS centroids obtained from each individual pure spectrum, making the nonlinear and systematic centroiding error worse and even intractable. For this reason, the conventional co-elution deconvolution approach in common use, called AMDIS (Automated Mass Spectral Deconvolution & Identification System) as reported in “Optimization and Testing of Mass Spectral Library Search Algorithms for Compound Identification” Stein, S. E.; Scott, D. R. J. Amer. Soc. Mass Spectrom. 1994, 5, 859-866, which typically operates with MS centroid data through examination of XICs (extracted ion chromatograms) and their differences, often fails to determine the correct number of co-elution compounds, derive the correct separation time profiles (called chromatograms in the case of chromatographic separation) of individual compounds or analytes, or compute the correct pure component/analyte mass spectra for reliable library (e.g., NIST EI MS library) search and compound identification. When there is not enough retention time separation (difference) between the XICs of co-eluting compounds, leading to severe collinearity in chromatograms, the entire deconvolution approach would collapse, giving seemingly arbitrary results with deconvoluted pure component spectra having severe spectral cross talks, resulting in both positive and negative spectral intensity values.

Accordingly, it would be desirable and highly advantageous to have methods that do not rely on XICs of centroided mass spectral data for deconvolution of mixtures to overcome the above-described deficiencies and disadvantages of the prior art.

### SUMMARY OF THE DISCLOSURE

The present application is directed to the following improvements:
1. An accurate approach to determine whether a chromatographic peak is pure or not (i.e., containing multiple analytes) and an initial list of possible analytes contained in the chromatographic peak through several different ways of performing mass spectral library searches, including both forward and reverse spectral library searches and subspace projection searches.
2. The list of possible analytes are filtered based on their retention index (RI) values falling within a given RI range to form a subset of possible analytes to be further considered, and the RI could be conveniently obtained using the positively identified analytes from the test sample run itself, even without the use of any standards or requiring a separate injection. Reference is made to U.S. Provisional Patent Application Ser. No. 63/305,969 (corresponding to PCT/US23/12187 filed on Feb. 2, 2023.
3. An accurate approach for the determination of independent analytes contained in a chromatographic peak, through multivariate statistical analysis such as the principal component analysis (PCA) or multiple linear regression between a mixture spectrum and the subset of possible analytes, even when there is no chromatographic separation among the analytes contained in the mixture.
4. With each analytes' mass spectrum identified, it is feasible to compute the pure chromatogram for each analyte through multiple linear regression for either semi-quantitation through relative ratioing or full quantitation through standard curves. Reference is made to U.S. Pat. No. 7,577,538.
5. Regression statistics such as fitting residuals, t-statistics, error bars, the relative number of negative chromatographic intensity values etc. can be utilized throughout the regression analysis to help remove or add analytes in an iterative process to arrive at a final set of identified analytes and their pure chromatograms along with the corresponding confidence levels.

Each of these aspects will be described below along with experimental results to demonstrate their utilities.

### BRIEF DESCRIPTION OF THE DRAWINGS

FIG. 1 is a block diagram of a mass spectrometer system coupled to a separation device that can utilize the methods disclosed herein.

FIG. 2 includes a flow chart of one embodiment disclosed herein.

FIG. 3 shows a segment of the Total Ion Chromatogram (TIC) obtained from a GC/MS analysis of a sample containing Volatile Organic Compounds (VOCs).

FIG. 4A and FIG. 4B show a plot of sorted search scores using the approach disclosed herein, where the bottom is a zoomed-in version of the top graph showing the top 20 hits.

FIG. 5 shows a segment of the Total Ion Chromatogram (TIC) obtained from a GC/MS analysis of a sample containing Volatile Organic Compounds (VOCs) with a co-eluting peak at RT=1.80 min.

FIG. 6 shows the profile mode mass spectral data of the mixture and the two deconvoluted spectral components found.

FIG. 7 shows a segment of the Total Ion Chromatogram (TIC) obtained from a GC/MS analysis of a sample containing Volatile Organic Compounds (VOCs) with a co-eluting peak at RT˜5.35 min.

FIG. 8 shows the profile mode mass spectral data of the mixture and the two deconvoluted spectral components found.

A component or a feature that is common to more than one drawing is indicated with the same reference number in each of the drawings.

### DETAILED DESCRIPTION OF THE PREFERRED EMBODIMENTS

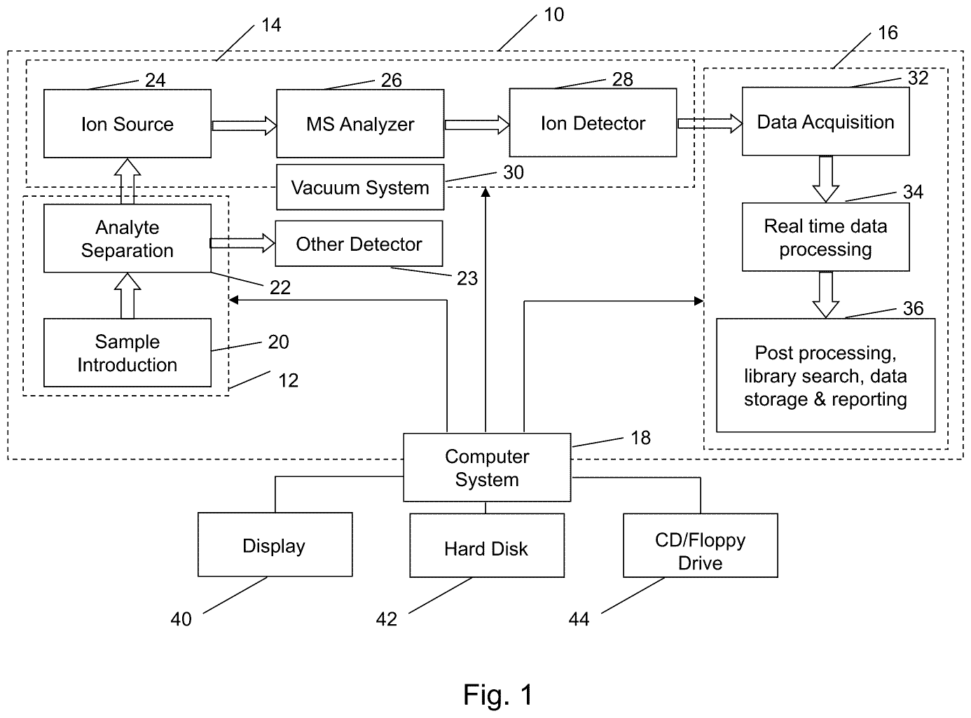

Referring to FIG. 1, there is shown a block diagram of an analysis system 10, that may be used to analyze proteins or other molecules, as noted above, incorporating features of the present invention. Although the present invention will be described with reference to the single embodiment shown in the drawings, it should be understood that the present invention can be embodied in many alternate forms or embodiments. In addition, any suitable types of components could be used.

Analysis system 10 has a sample preparation portion 12, other detector portion 23, a mass spectrometer portion 14, a data analysis system 16, and a computer system 18. The sample preparation portion 12 may include a sample introduction unit 20, of the type that introduces a sample containing proteins, peptides, or small molecule drug of interest to system 10, such as LCQ Deca XP Max, manufactured by Thermo Fisher Scientific Corporation of Waltham, MA, USA. The sample preparation portion 12 may also include an analyte separation unit 22, which is used to perform a preliminary separation of analytes, such as the proteins to be analyzed by system 10. Analyte separation unit 22 may be any one of a chromatography column, an electrophoresis separation unit, such as a gel-based separation unit manufactured by Bio-Rad Laboratories, Inc. of Hercules, CA, or other separation apparatus such as ion mobility or pyrolysis etc., as is well known in the art. In electrophoresis, a voltage is applied to the unit to cause the proteins to be separated as a function of one or more variables, such as migration speed through a capillary tube, isoelectric focusing point (Hannesh, S. M., Electrophoresis 21, 1202-1209 (2000), or by mass (one dimensional separation)) or by more than one of these variables such as by isoelectric focusing and by mass. An example of the latter is known as two-dimensional electrophoresis.

The mass spectrometer portion 14 may be a conventional mass spectrometer and may be any one available, but is preferably one of TOF, quadrupole MS, ion trap MS, qTOF, TOF/TOF, or FTMS. If it has an electrospray ionization (ESI) ion source, such ion source may also provide for sample input to the mass spectrometer portion 14. In general, mass spectrometer portion 14 may include an ion source 24, a mass analyzer 26 for separating ions generated by ion source 24 by mass to charge ratio, an ion detector portion 28 for detecting the ions from mass analyzer 26, and a vacuum system 30 for maintaining a sufficient vacuum for mass spectrometer portion 14 to operate most effectively. If mass spectrometer portion 14 is an ion mobility spectrometer, generally no vacuum system is needed and the data generated are typically called a plasmagram instead of a mass spectrum.

In parallel to the mass spectrometer portion 14, there may be another detector portion 23, to which a portion of the flow is diverted, for nearly parallel detection of the sample in a split flow arrangement. This other detector portion 23 may be a single channel UV detector, a multi-channel UV spectrometer, or Reflective Index (RI) detector, light scattering detector, radioactivity monitor (RAM) etc. RAM is most widely used in drug metabolism research for ¹⁴C-labeled experiments where the various metabolites can be traced in near real time and correlated to the mass spectral scans.

The data analysis system 16 includes a data acquisition portion 32, which may include one or a series of analog to digital converters (not shown) for converting signals from ion detector portion 28 into digital data. This digital data is provided to a real time data processing portion 34, which processes the digital data through operations such as summing and/or averaging. A post processing portion 36 may be used to do additional processing of the data from real time data processing portion 34, including library searches, data storage and data reporting.

Computer system 18 provides control of sample preparation portion 12, mass spectrometer portion 14, other detector portion 23, and data analysis system 16, in the manner described below. Computer system 18 may have a conventional computer monitor or touch display 40 (or keyboard) to allow for the entry of data on appropriate screen displays, and for the display of the results of the analyses performed. Computer system 18 may be based on any appropriate personal computer, operating for example with a Windows® or UNIX® operating system, or any other appropriate operating system. Computer system 18 will typically have a hard drive 42 or other type of data storage medium, on which the operating system and the program for performing the data analysis described below, is stored. A removable data storage device 44 for accepting a CD, floppy disk, memory stick or other data storage medium is used to load the program on to computer system 18. The program for controlling sample preparation portion 12 and mass spectrometer portion 14 will typically be downloaded as firmware for these portions of system 10. Data analysis system 16 may be a program written to implement the processing steps discussed below, in any of several programming languages such as C++, JAVA or Visual Basic.

It should be noted that for a more general separation with spectral detection system that this disclosure is applicable to, the ion source portion 24 may be replaced by a power source including a light source for optical detection systems or an X-Ray energy source for X-Ray systems. MS analyzer portion 26 may be replaced by a dispersive apparatus such as grating for optical systems with or without fluorescence option, and the ion detector portion 28 may be replaced with the appropriate corresponding light or energy detectors.

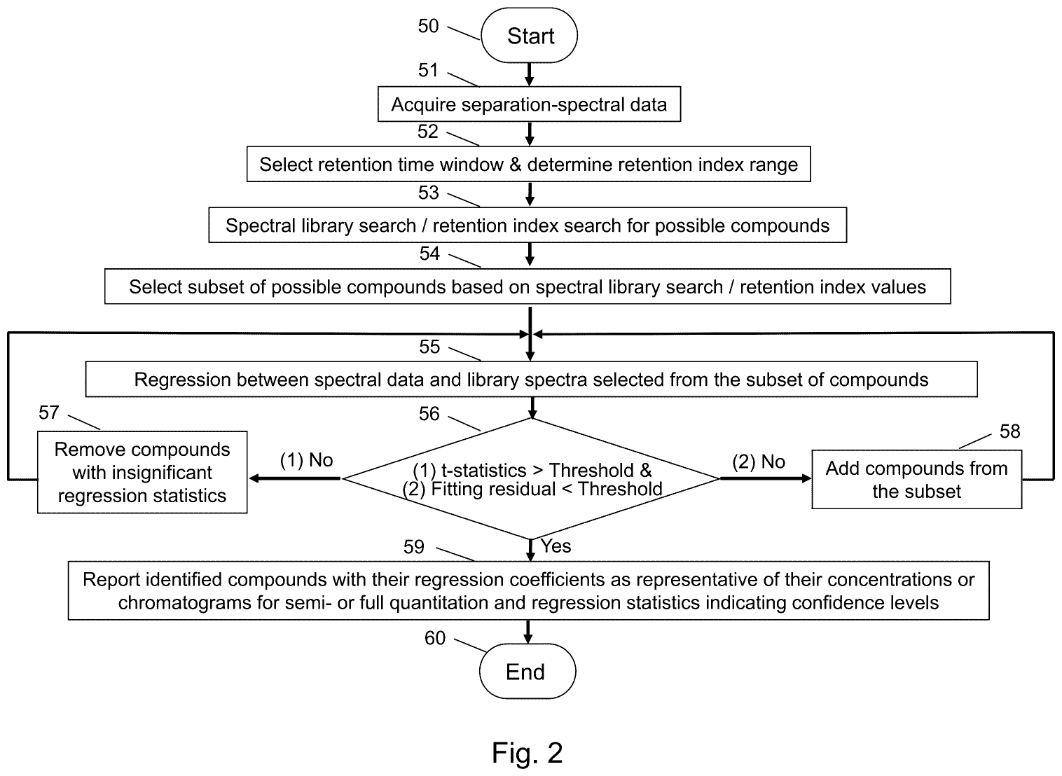

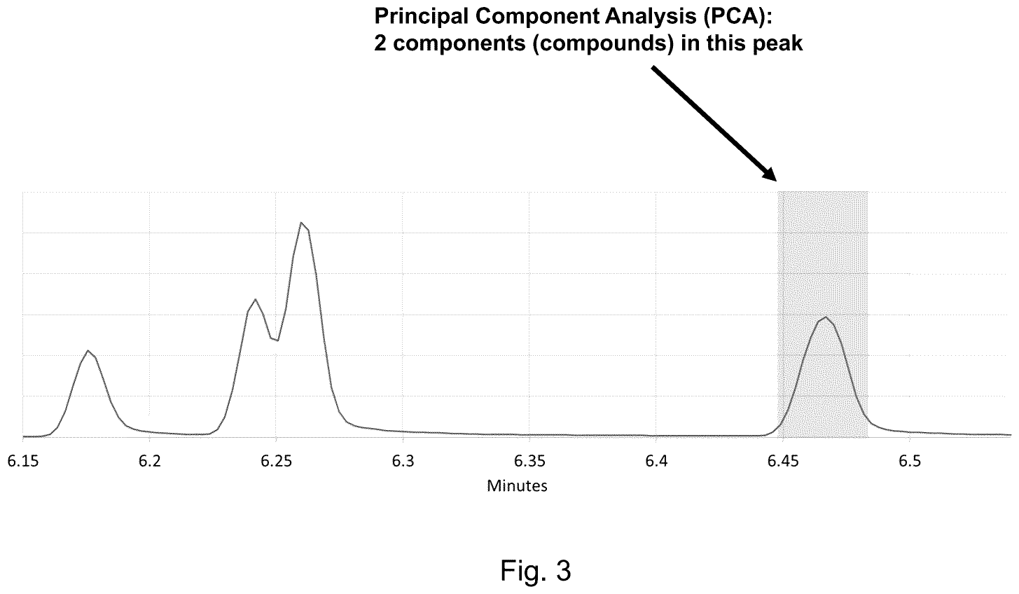

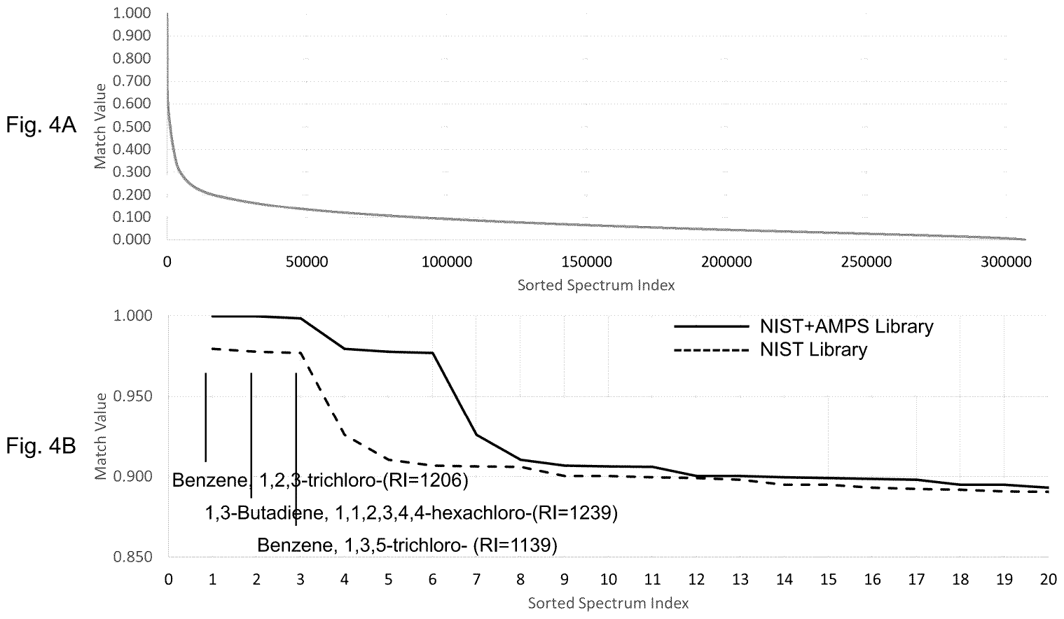

In the preferred embodiment, a sample is acquired through the chromatography/mass spectrometry system described in FIG. 1 with mass spectral data continuously acquired throughout the run, resulting in a data run such as the one shown in FIG. 2, which is an example GC/MS run containing many chromatographic peaks. As described in the co-pending U.S. provisional application Ser. No. 63/305,969 (corresponding to PCT/US23/12187 filed on Feb. 2, 2023), the detected peaks identified with high confidence through mass spectral library search in the entire sample run can be used as the naturally occurring “standards” to calibrate the retention index (RI) for this entire run or any other run under essentially the same chromate-graphic or other separation conditions including stationary phases and carrier gas in this case. This process can be used to select a well-spaced subset of reliably identified compounds as internal RI calibration standards to accurately calibrate all the chromatographic peaks in the whole run for RI (Auto RI), without any additional experimental work at all. Alternative to Auto RI, the conventional external RI calibration standards such as n-alkanes could also be injected separately for RI calibration and then applied to a sample run to obtain the RI values of all chromatographic peaks in the run. The RI values for all peaks in the run can not only be assigned to further improve the compound identification above and beyond a (NIST) spectral library search alone, as disclosed in co-pending application, the above mentioned provisional application Ser. No. 63/305,969 (corresponding to PCT/US23/12187 filed on Feb. 2, 2023); they can also be utilized as a filter to aid in the identification and analysis of co-eluting mixture peaks in the chromatogram. The flow of the process is depicted in the flowchart of FIG. 2 and is described as follows:
a. Acquire mass spectral data during the separation process (FIG. 2, Step 51), preferably in the raw profile mode, for reasons outlined earlier and for best possible accuracy, including the possibility of obtaining accurate mass measurements using the method from the U.S. Pat. Nos. 6,983,213 and 7,493,225.
b. For each chromatographic peak detected, select the corresponding retention time (RT) window and use the retention time calibration methods described above to obtain the corresponding range of RI values (FIG. 2, Step 52). This RI range may be user-expanded somewhat to accommodate the possible RI determination errors, e.g., 10-20 retention index unit (iu).
c. Use mass spectral data within the RT window to perform a mass spectral library search to find a subset of possible compounds whose retention index values tabulated in the spectral library are within the RI range determined above (FIG. 2, Step 53). Various spectral search methods could be utilized here, either alone or in combination:
   i. Using the averaged mass spectral data within the RT window to perform a conventional spectral library search, also called a forward search, which measures the spectral similarity between the averaged mass spectrum and the library spectrum of a possible compound, with search scores normalized to 0-1000 where 1000 is a perfect match. A specified “good” threshold, e.g., more than 900 score from NIST forward search, is typically considered a high quality hit or match, indicating a pure single compound contained in the averaged mass spectrum, even though there may be multiple hits with a search score of more than 900. One could then filter out those compounds with high quality search scores having RI values outside of the RI range specified, e.g., spectrally similar isomers with different RI values, leaving only those with RI values within the RI range in a subset for further consideration below (FIG. 2, Step 54).
   ii. For co-elution compounds where a detected chromatographic peak contains a mixture of more than a single compound leading to compromised forward search score due to the presence of spectral interferences, NIST reverse search has been shown to possibly return a very high score for those compounds that are part of the mixture, due to the masking or elimination of irrelevant m/z values coming from spectral interferences. The search score difference (e.g., <50) between the reverse and forward search can therefore be used not only as a good indicator of peak purity here, but also as a way to search for and find those compounds with high reverse search scores (e.g., >850) but low forward search score that may be part of the mixture. For mixtures containing exactly two co-eluting compounds, at least two compounds are expected to have high quality reverse search scores. In practice and by default, a NIST spectral library search has a built-in prefilter to automatically focus exclusively on the likely high quality hits in order to speed up the search, which may inadvertently filter out the minor mixture components or any component beyond the second components for a 3- or more-component mixture. In order to improve the chance of having the most relevant compounds at or near the top of the hit list, the prefilter may be turned off at the expense of a slower search or a customized multi-core search engine could be programmed and used instead, using optimized SIMD assembly language algorithms and multi-tasking capable of searching against 300,000 library compounds in a few milliseconds, as disclosed in co-pending application provisional Patent Application Ser. No. 63/273,676. As in a forward search, there may be multiple hits with more than the threshold (e.g., >850) reverse search score. One can then filter out those compounds with high quality search scores having RI values outside of the RI range specified, e.g., spectrally similar isomers with different RI values, leaving only those with RI values within the RI range in a subset for further consideration below (FIG. 2, Step 54). It should be appreciated here that, unlike conventional deconvolution such as AMDIS, this approach does not require any difference in the RT or chromatograms of mixture components and works even for compounds with exactly the same RT or identical chromatograms.
   iii. As disclosed in the co-pending application Ser. No. 63/273,676, one can also perform a Principal Component Analysis (PCA) on a matrix composed of all the mass spectral data within the RT window to determine the number of linearly independent components contained in the mixture. Furthermore, one can construct a subspace using the principal components determined and project each and every library spectrum onto the subspace to measure the relative vector length between the projected version of the library spectrum to that of the original library spectrum, a value between 0.0-1.0. If the projected library spectrum is of the same length as that of the original library spectrum, the library spectrum is considered to be inside the subspace spanned by the mass spectral data array within the RT window, i.e., the library spectrum is one of the mixture components. Any library spectrum with a shorter projected vector length is likely to be outside of the subspace and therefore not one of the mixture components. A list of high-quality hits with relative lengths approaching 1.0 will likely include all components detected within the RT window, their spectrally similar isomers, and duplicate library entries. By selecting those having RI values within the RI range specified, a shorter list of possible compounds will be retained in a subset for further consideration below (FIG. 2, Step 54). It should be noted here that, as for AMDIS, this PCA based spectral search would require enough statistical difference in the RTs or chromatograms of mixture components. Unlike the forward or reverse search described above, on the other hand, this PCA based spectral search works for any number of linearly independent components beyond the binary 2-component mixtures and regardless of the degree of spectral overlap among the components. The two closely co-eluting compounds from FIG. 3 can be found among the top hits from this subspace search as shown in FIG. 4A and FIG. 4B, using both the NIST library and an augmented version of the NIST library after adding the accurate mass profile mode mass spectral data of typically found VOCs. The top 3 hits in both cases include the two correct compounds with their respective RI values within the specified RI range whereas the third hit, 1,3,5-trichloro-benzene (RI=1139) is an isomer of the top (correct) hit 1,2,3-trichloro-benzene with a very different RI value (RI=1206).
d. Each mass spectrum from the RT window should be a linear combination of all components' library mass spectra selected from the subset of possible compounds identified above, where the linear combination coefficients and regression statistics including fitting residuals, t-statistics, and error bars can be estimated through Multiple Linear Regression (MLR, FIG. 2, Step 55), with references made to U.S. Pat. Nos. 7,577,538 and 6,983,213. The linear combination coefficients are representative of the chromatographic profiles over the RT window (chromatograms) and are proportional to the relative concentrations of the underlying components. As mentioned, some of the library spectra within the subset of compounds determined above may have come from the same compound measured only slightly differently by another user and saved in a different library, from isomers with similar enough RI values, or compounds with similar mass spectra under EI such as higher n-alkanes. For an MLR regression model to work reliably, it is advantageous to select a certain smaller number (user specified or PCA determined, for example) of compounds with the most distinct library mass spectra as the component spectra to be linearly fitted to each measured mass spectrum at a given RT or averaged or summed mass spectrum from within the RT window. Reference is made to Analytical Chemistry, 1991, 63, 2750-2756 on the selection of most distinct spectral responses.
e. Using the fitting or regression statistics including fitting residual, t-statistics, or error bars and through inspection of the resulted chromatograms from MLR (FIG. 2, Step 56), one can iterate and refine the components included in the MLR model by adding components with statistically significant (large enough) t-statistics (FIG. 2, Step 57), or removing components with statistically insignificant (small enough) t-statistics (FIG. 2, Step 58), until a maximum number of statistically significant components have been included with all fitting residual below a given threshold (FIG. 2, Step 56). One could also inspect the resulted chromatograms for the relative or absolute number of negative intensity values and remove or delete those components with high numbers of negative intensities. As an alternative to these iterative steps, one could also perform an all possible combination of all the compounds analysis in the subset, and come up with the best combination of compounds with the smallest fitting residual and all statistically significant t-statistics for the estimated chromatograms. It should be appreciated here that, unlike conventional deconvolution such as AMDIS, this approach does not require any difference in the RT or chromatograms of mixture components and would work even for compounds with exactly the same RT or identical chromatograms.
f. With all statistically significant components found and a fitting residual below a given threshold, the final estimated chromatograms are obtained in the form of regression coefficients which are proportional and representative of the relative concentrations of the components or compounds found. One can then proceed with the semi-quantitation of these compounds through peak area integration and/or relative ratioing. It is also feasible now to perform a full quantitation using a known series of standard concentrations through standard curves. This is accomplished in Step 59 in FIG. 2.

Due to the difference in data sampling and data interval between the acquired mass spectral data and variously built spectral libraries, it may be necessary to perform down- or up-sampling via interpolation, convolution, zero filling, centroiding, shifting or a combination of these if needed and when necessary, either all at once beforehand or on-the-fly during the analysis, in order to keep the data array size consistent and mutually compatible between mass spectral data, as disclosed in the co-pending provisional application Ser. No. 63/273,676 mentioned above,

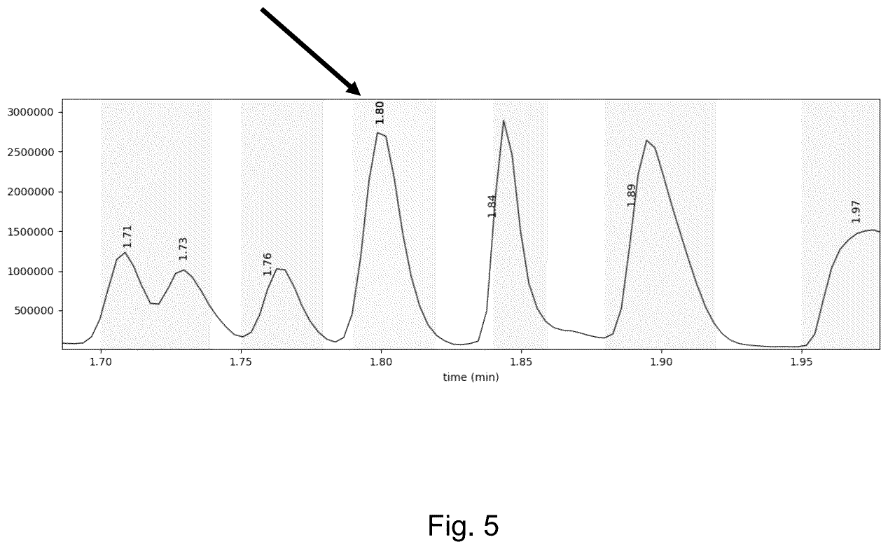

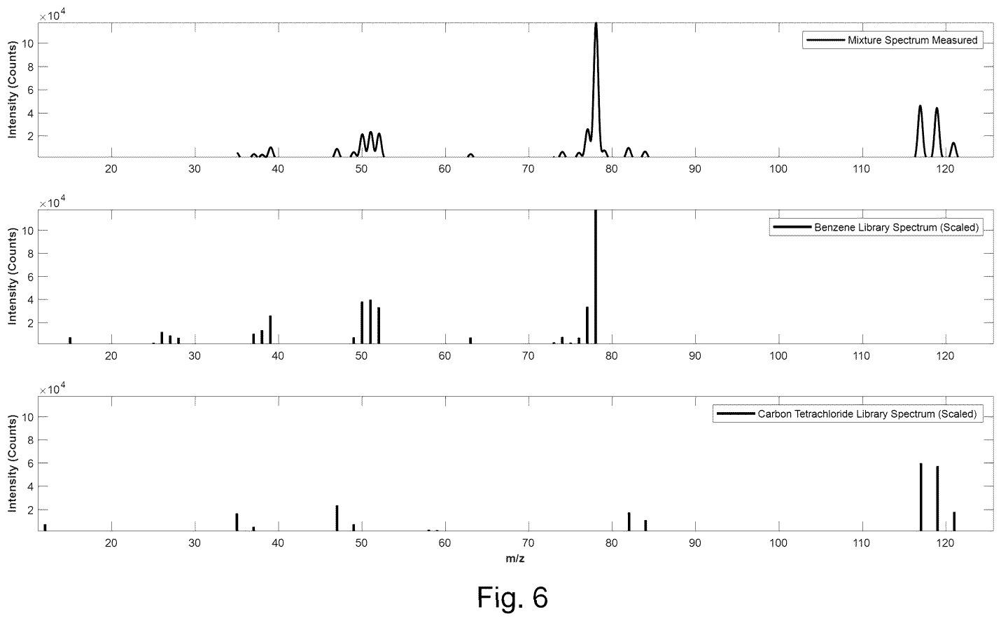

Some examples of the process are illustrated in the following figures. FIG. 5 shows a section of total ion chromatogram (TIC) from a GC/MS analysis of a sample containing VOCs. The peak at RT=1.8 minutes is the coelute of benzene and carbon tetrachloride which cannot be deconvoluted by conventional means including AMDIS due to the minimal GC separation with only 9 index unit (iu) difference in their RI values. FIG. 6 shows a composite profile mode spectrum along with the deconvoluted centroid library spectra of the two co-eluting compounds identified, one for carbon tetrachloride and the other for benzene.

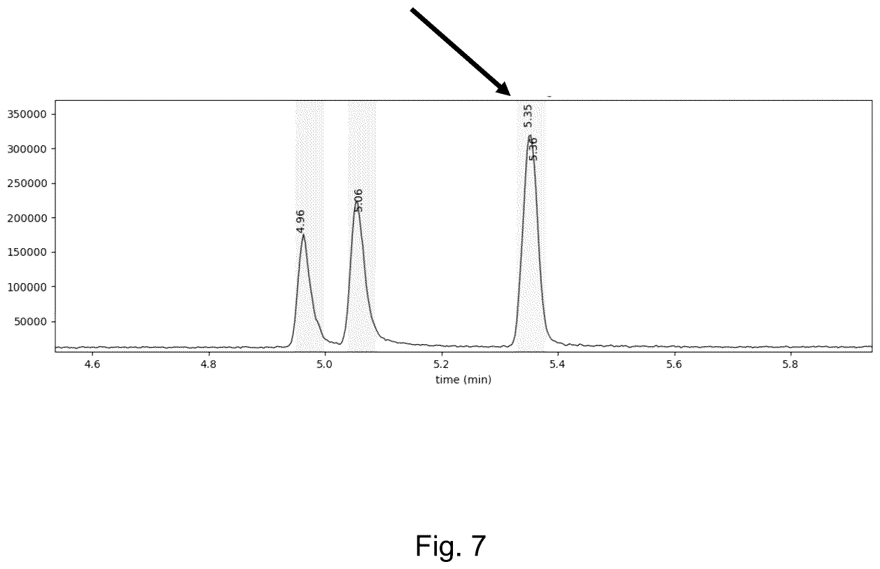

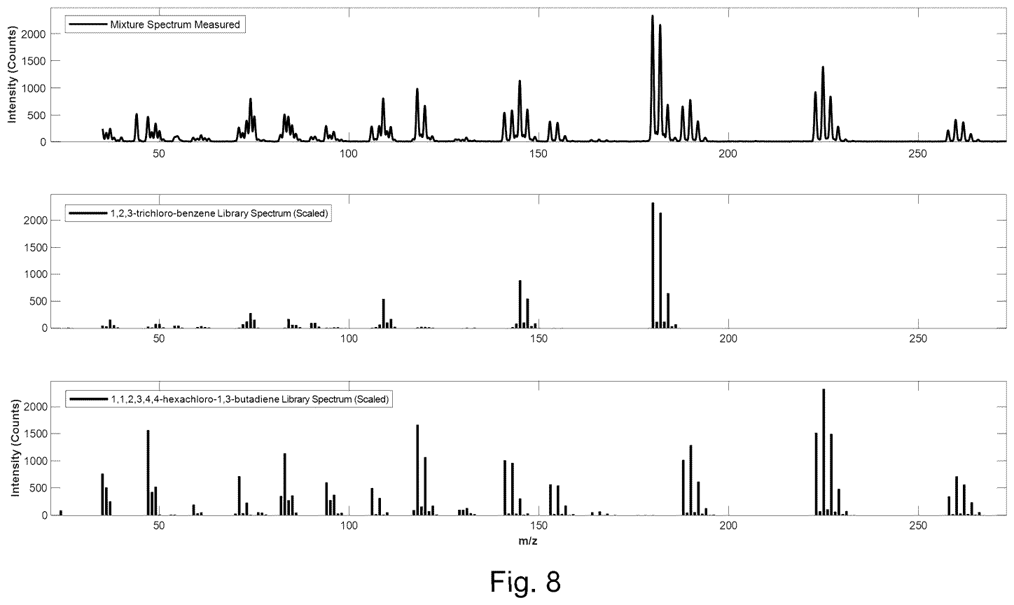

FIG. 7 shows a peak at RT of approximately 5.35 minutes where conventional deconvolution failed. In this case, the peaks coeluted even though the RI of the compounds is separated by a relatively large 25 iu, due to the “fast” chromatography which allows for faster but less well resolved runs. It is noted that the peak positions are placed at 5.35 min for 1,2,3-trichloro-benzene and 5.36 min for 1,1,2,3,4,4-hexachloro-1,3-butadiene. FIG. 8 shows a composite profile mode spectrum along with the deconvoluted centroid library spectra of the two co-eluting compounds identified, one for 1,1,2,3,4,4-hexachloro-1,3-butadiene and the other for 1,2,3-trichloro-benzene.

Although the description above contains many specifics, these should not be construed as limiting the scope of the invention but as merely providing illustrations of some feasible embodiments. For example, there are certain advantages in acquiring the spectral data in the raw profile mode and calibrating the profile mode spectral data for mass accuracy and spectral accuracy, as disclosed in U.S. Pat. Nos. 7,577,538 and 6,983,213, for the creation, augmentation, or utilization of accurate profile mode spectral data and library, as disclosed in the U.S. provisional patent application Ser. No. 62/830,832, filed on Apr. 8, 2019 and as in U.S. patent application Ser. No. 16/843,505 published as US 2020-0232956 A1.

Additionally, the MLR regression analysis may optionally include one of spectral baseline or background as additional spectral components to be considered and fitted to the measured mass spectral data to compensate and account for their spectral contributions, which may arise from a bleeding column and therefore RT, m/z, and temperature-programming dependent. These baseline or background components may be incorporated via either theoretical computation based on assumed dependence on variables such as m/z, or the actual measured spectral data from one of blank or control sample from one of the same or nearby retention time windows under the same or similar GC separation or programming conditions.

Thus the scope of the disclosure should be determined by the appended claims and their legal equivalents, rather than by the examples given. Although the present disclosure has been described with reference to the embodiments described, it should be understood that it can be embodied in many alternate forms of embodiments. In addition, any suitable size, shape or type of elements or materials could be used. Accordingly, the present description is intended to embrace all such alternatives, modifications and variances which fall within the scope of the appended claims.

It will be understood that the disclosure may be embodied in a computer readable non-transitory storage medium storing instructions of a computer program which when executed by a computer system results in performance of steps of the method described herein. Such storage media may include any of those mentioned in the description above.

The techniques described herein are exemplary and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof

What is claimed is:

1. A method for the analysis of compounds of interest through separation over time when using a mass spectral detection system, comprising the steps of
a. acquiring mass spectral data for a sample;
b. selecting a relevant retention time window for presence of possible compounds of interest;
c. using positively identified analytes from a sample run to convert retention time into retention index
d. determining a retention index range for said relevant retention time window;
e. using the acquired spectral data in said relevant retention time window to perform a spectral library search to identify possible compounds;
f. selecting a subset of possible compounds based on at least one of their retention index values and spectral library search scores;
g. performing a regression analysis, between the spectral data within said retention time window and the library spectrum of at least one of a subset of possible compounds; and
h. reporting the regression coefficients as representative of the concentrations or chromatograms of said possible compounds.

2. The method of claim 1, where the technique for separation is one of gas chromatography (GC), liquid chromatography (LC), supercritical fluid chromatography, ion chromatography (IC), capillary electrophoresis (CE), gel electrophoresis, ion mobility, and pyrolysis.

3. The method of claim 1, where the mass spectral detection system is one of a sector mass spectrometer, quadrupole mass spectrometer, ion trap mass spectrometer, Time-of-Flight (TOF) mass spectrometer, Orbitrap mass spectrometer, Fourier-transform ion cyclotron resonance (FT ICR) mass spectrometer.

4. The method of claim 1, where the retention time includes one of chromatographic retention time, elution time, drift time, and separation time.

5. The method of claim 1, where the retention index values have been previously obtained from measured retention times through the use of calibration standards referenced to n-alkane for gas chromatography.

6. The method of claim 1, where the retention index values are obtained from a retention index calibration curve built from the same data acquisition using co-existing compounds with known retention index values after positive identification through a spectral library search.

7. The method of claim 1, where the regression model is a multiple linear regression model, with optional background components included.

8. The method of claim 1, where the spectral search involves the projection of a library spectrum onto the subspace spanned by the spectral data within the retention time window range.

9. The method of claim 1, where the subset is selected based on reverse spectral library search quality above a given quality threshold.

10. The method of claim 1, where the subset is selected based on one of the difference between and combination of a forward and a reverse spectral search.

11. The method of claim 1, further comprising reporting regression statistics, including one of regression residual, error bars and t-statistics, for each possible compound.

12. The method of claim 11, where the regression statistics are used to refine the regression model in an iterative process by one of removing or adding possible compounds.

13. The method of claim 11, where the regression statistics are used to determine the number of possible compounds included in the regression model.

14. The method of claim 1, where principal component analysis (PCA) is used to determine the number of possible compounds included in the regression model.

15. The method of claim 1, wherein a possible compound having reported concentrations or chromatograms indicating lower than a given positive or negative threshold is removed from the regression.

16. The method of claim 1, where regression coefficients representative of the compound concentrations or chromatograms after area integration are used for one of semi-quantitation based on relative ratioing and full quantitation based on standard curves.

17. The method of claim 1, where the regression analysis includes one of spectral baseline or background as additional spectral components to be considered.

18. The method of claim 17, where one of the spectral baseline or background is theoretically computed based on assumed dependence on m/z.

19. The method of claim 17, where one of the spectral baseline or background is the actual measured spectral data from one of blank or control sample from one of the same or nearby retention time windows.

20. A mass spectral detection system including a mass spectrometer operating in accordance with any of the method of claim 1.

21. For use with a computer associated with a mass spectral detection system including a mass spectrometer, a computer readable medium having computer readable program instructions readable by the computer for causing the spectral detection system to operate in accordance with the method of claim 1.
